(19) United States
(12) Patent Application Publication
(10) Pub. No.: US 2024/0244518 A1
(43) Pub. Date: Jul. 18, 2024

(54) Mobile and Stationary Wireless Communication System and Method

(71) Applicant: 6Harmonics Inc., Ottawa (CA)

(72) Inventor: Andrew Spurgeon, Sharon (CA)

(21) Appl. No.: 18/412,499

(22) Filed: Jan. 13, 2024

Related U.S. Application Data
(60) Provisional application No. 63/479,998, filed on Jan. 14, 2023.

(51) Int. Cl. H04W 48/20; H04W 48/16

(52) U.S. Cl. CPC H04W 48/20; H04W 48/16

(57) ABSTRACT

A method and system for fast roaming is disclosed. A mobile communication device in communication with a first access point via a first protocol is provided. A lookup table comprising data relating to access points and geographical location data is also provided. For a location of the mobile communication device in relation to the geographical location data, a second other access point is retrieved from the lookup table, the second other access point accessible based on the location of the mobile communication device. Then, the mobile communication device is wirelessly connected for communication via the second other access point and disconnected from the first access point.

### FIELD OF THE INVENTION

The invention relates to wireless networking and more particularly to wireless networks for mobile users.

### BACKGROUND

Wireless communication architectures are plentiful, and each has advantages and drawbacks. For example, legacy transmitters broadcast voice communication over a significant distance but could also be listened in on, ‘intercepted,’ by anyone who wanted to listen. Point to point communication was private but required significant setup and two stationary ‘points.’ Modern wireless cellular communication provides private communication transmitted via a network spanning thousands of miles and supported by countless cellular towers, base stations, and countless wireless handheld devices. In use, each wireless device negotiates with available cellular towers, those within communication range, to determine a ‘best’ choice, the cellular tower most likely to support a high standard of service. This ‘best’ choice is often dependent upon availability, noise, bandwidth, and signal strength. It is also dependent upon permission as some cellular towers are only for use by some individuals.

Determination of a ‘best’ cellular tower is performed based on a predefined protocol and that protocol is designed for the communication and encoding protocols of the wireless communication.

Other wireless protocols are designed to support stationary users. These protocols require significantly fewer operations because once connected to a wireless access point, a user is not expected to move. For example, WIFI is a protocol intended for users and devices that are typically stationary. As such, WIFI is commonly used for laptops, televisions, etc.

Due to its limited range, WIFI is a wonderful stationary protocol providing excellent communication to devices within, for example, a home or a coffee shop. Small movements such as moving from one table to another have little effect on communication with an access point and since the access point is selected and authenticated, signal strength is typically not an issue.

With the advent of smart phones, there have been a lot of wireless devices connecting to WIFI networks. This presents a new challenge. Smart phones tend to move with their owner and cover large distances in a single day. For streaming of video and unlike a television, smart phones are truly mobile. Unlike a laptop, smart phones are typically “on and available” while they move.

In the IEEE 802.11r spec “fast roaming” is introduced, but the specification primarily focuses on security and key re-negotiation as each of these problems consumes valuable processor resources. Unfortunately, they are not the only reasons that “roaming” is slow in WIFI implementations.

In some instances, it would be advantageous to adapt a less mobile architecture to operate for a mobile implementation.

### SUMMARY OF EMBDIMENTS

In accordance with an embodiment there is provided a method comprising: providing a mobile communication device in communication with a first access point via a first protocol; providing a lookup table comprising data relating to access points and geographical location data; determining a location of a mobile communication device in relation to the geographical location data; retrieving from the lookup table a second other access point accessible based on the location of the mobile communication device; wirelessly connecting the mobile communication device to the second other access point; and disconnecting the mobile communication device from the first access point.

In some embodiments, the first protocol is a WIFI protocol.

In accordance with an embodiment there is provided a method comprising: providing a lookup table comprising data relating to a plurality of access points and associated geographical location data; providing a mobile communication device in communication with a network via a first access point of the plurality of access points; determining a location of the mobile communication device; retrieving from the lookup table at least a second access point accessible from the location of the mobile communication device; when the first access point is one of the at least a second access point, maintaining wireless communication via the first access point; and when the current access point is other than one of the at least a second access point, wirelessly communicating with the network via an access point of the at least a second access point.

In accordance with an embodiment there is provided a method comprising: providing a lookup table comprising data relating to a plurality of geographical locations and for each location an associated access point and quality level for said associated access point; providing a mobile communication device in communication with a network via a first access point of the plurality of access points; determining a location of the mobile communication device; retrieving from the lookup table at least a second access point accessible from the location of the mobile communication device and having a higher quality level associated therewith; when the first access point has a quality level above a predetermined threshold and is one of the at least a second access point, maintaining wireless communication via the first access point; and when the current access point is at least one of below the predetermined threshold and other than one of the at least a second access point, wirelessly communicating with the network via an access point of the at least a second access point.

In accordance with an embodiment there is provided a method comprising: providing a lookup table comprising data relating to access points and geographical location data; determining a first access point through which wireless communication of a mobile communication device is occurring; retrieving from the lookup table a geofence for the first access point; monitoring a location of the mobile communication device to see when the mobile communication device is outside the geofence of the first access point; when the mobile communication device is outside the geofence of the first access point, looking up a second other access point within the lookup table based on a geolocation of the mobile communication device; and establishing communication with the network via the second other access point.

In accordance with an embodiment there is provided a method comprising: providing a lookup table comprising data relating to access points and geographical location data; providing a first access point; and providing a first mobile communication device in communication with the first access point; when a signal quality received at the first mobile device is below a first threshold,
a) determining a location of the first mobile communication device
b) retrieving from the lookup table access points other than the first access point accessible from the location of the first mobile communication device;
c) disconnecting from the first access point; and
d) connecting to a one of the retrieved access points.

In accordance with an embodiment there is provided a method comprising: forming a dataset comprising in a first mode of operation transmitting from a mobile communication device for each of a plurality of geographic location geographic location data, access points available, and signal quality for at least one of the access points available; and forming a lookup table including the received data and indexable by geographic location.

In accordance with an embodiment there is provided a method comprising: forming a dataset comprising data relating to access points comprising: receiving a request for data lookup from a mobile communication device, the request including a current access point and a signal quality; and storing data within the lookup table relating to the geolocation, the current access point and the signal quality.

In accordance with an embodiment there is provided a method comprising: forming a dataset comprising data relating to access points comprising: receiving a request for data lookup from a mobile communication device, the request including a current access point and a signal quality; and comparing the current access point and signal quality to the signal quality for the same current access point within the lookup table and when they are substantially different, storing data relating to at least one of a difference and the signal quality within the lookup table.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified diagram of a communication network;

FIG. 2 is a simplified diagram of a communication network;

FIG. 3 is a simplified flow diagram of a method of changing access points within one or more WIFI networks;

FIG. 4 is a simplified flow diagram of a method of changing access points within one or more WIFI networks;

FIG. 5 is a simplified diagram of geography comprising two access points;

FIG. 6 is a simplified flow diagram of a method of changing between different types of networks in dependence upon a lookup table and a device location;

FIG. 7 is a simplified flow diagram of a method of populating a lookup table of access points;

FIG. 8 is simplified flow diagram of a method of maintaining and updating a lookup table of access points;

FIG. 9 is simplified flow diagram of a method of determining an access point based on a mobile device location, movement, and a geofence for available access points; and

FIG. 10 is a simplified flow diagram for a method of verifying an access point before connection.

### DETAILED DESCRITPION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Handoff is a term used referring to transferring one end of a communication from a first end point to a second other end point. For example, when a person with a mobile communication device moves from the coverage of a first base station to the coverage of a second other base station, the mobile device switches from communicating via the first base station to communicating via the second other base station in what is referred to as a “handoff.”

TVWS (or TV white space, or television white space) is a portion of the wireless communication spectrum including parts of the VHF and UHF bands initially allocated for television broadcast transmission and spacing therebetween and now unused in some areas, some different TVWS existing in some different geographic areas.

WIFI (or) is a group of wireless data communication protocols such as the 802.11 protocols. The WIFI protocol(s) are designed for wireless communication between a base station and a stationary wireless device such as a television, printer, or a laptop.

Mobile communication device is a mobile device intended to be used for communication both while stationary and while moving such as a mobile phone.

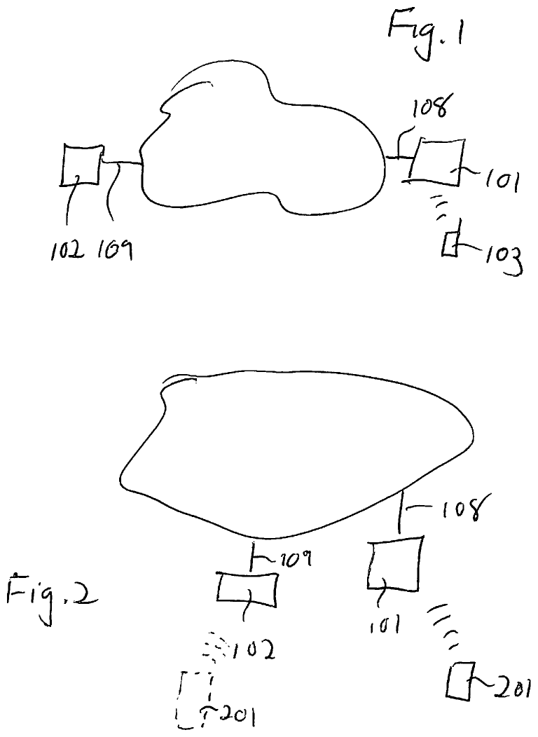

Referring to FIG. 1, shown is a typical prior art communication network. Here, a plurality of nodes 101 and 102 are coupled to a wide area network in the form of the internet via fibre optic connections 108 and 109. Node 101 supports an 802.11 wireless network thereabout for user system 103 using the service. The network provides 802.11 compliant communication to each wireless customer 103 so long as each node is operational and so long as communication to and from each node is uninterrupted. Each user system shown is stationary. For example, a user system might be a desktop computer, a television, etc. and connects to a node when started through a process including discovery, selection, authentication and so forth. For example, a laptop maintains a list of authorised WIFI networks for which it has credentials. When the laptop is started or is woken from sleep, it discovers which WIFI networks are available, selects the most preferred of available networks, authenticates to that WIFI network, receives communication address information for that network and begins communicating therethrough. Though this takes some time, it is not typically a sufficiently long time-duration to be of concern because it is executed one time at start-up which itself is not typically instantaneous. However, with some systems, the system completes start-up and is ready for use before the network is properly connected.

If the node through which the laptop is communicating fails, then the laptop searches for other available nodes. As this type of event is relatively infrequent, the efficiency and effectiveness of this process is not typically of concern. For example, if a business has a main node coupled to optical fibre and another wireless access point coupled to the node by ethernet, a user opening their laptop in range of the access point may authenticate to the access point even when the node is not operational and may fail to access the Internet. This is often the case, even when another access point is available that has access to the Internet. Once again, as systems in WIFI topologies are typically stationary, network failures are viewed as more globally applying and the efficiency of selecting a new access point is of little concern.

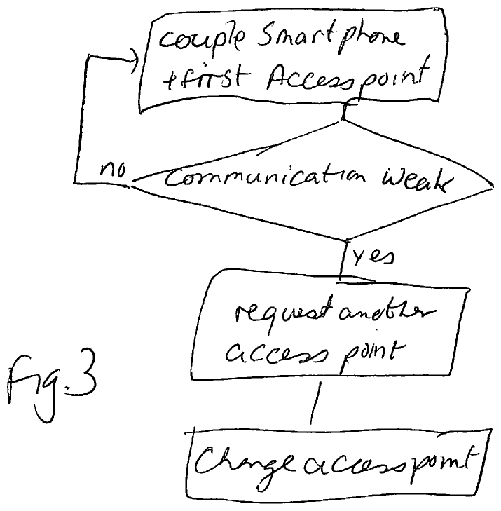

Referring to FIG. 2, shown is a typical prior art WIFI communication network of FIG. 1 but having a smart phone 201 in communication therewith. Whereas a laptop computer connects to a network and remains relatively stationary while in use, a smartphone is a truly mobile communication device, often in use during transport for navigation and communication. For example, one use of a smartphone is for listening to content streamed via the Internet.

When the smartphone of FIG. 2 moves away from access point 101 through which it is currently communicating and the signal degrades, for example resulting in communication problems, the smartphone terminates its connection to the access point 101 and begins searching for a new access point. For example, it notes that access point 102 has a signal strength sufficient to indicate a good potential connection and the smartphone 201 shown in dashed lines begins connecting to access point 102—the usual process of discovery, selection, and authentication. Thus, when listening to a podcast, there may be a short or longer silence while the connection is re-established, connecting to the access point 102. Unfortunately, if using WIFI for interpersonal communication such as video conferencing or voice over WIFI, the time between leaving the first access point to forming a new connection is quite long and disruptive. Often a call is dropped or canceled due to the delay.

Thus, for example, when walking around, a smartphone often connects and disconnects from networks that are known and within communication range. When a network is implemented for mobile communication, connection and disconnection times are typically acceptable because a network protocol is designed that way. However, when a network is designed for stationary use, such as WIFI, the connection and disconnection times are long relative to an acceptable interruption in communication. Similar disruptions can occur when switching from WIFI to LTE or 3G communications as the smartphone, even though it is connected to the cellular network, upon communication problems disconnects first from the WIFI and then switches ongoing communications over to the cellular network.

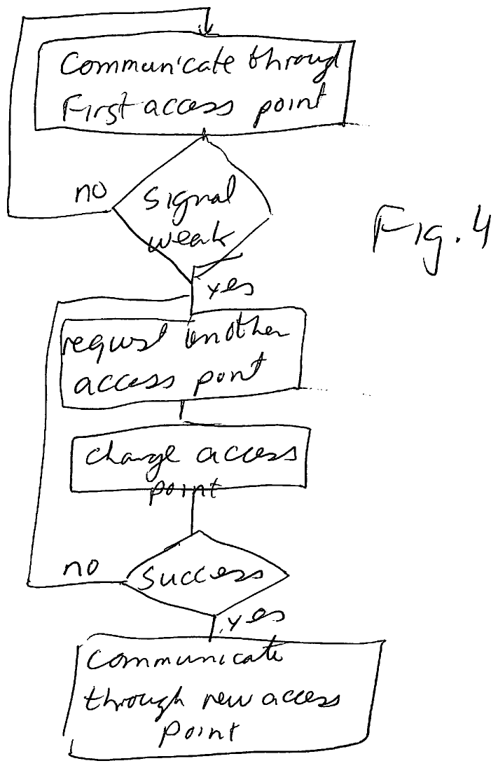

Referring to FIG. 3, shown is a simplified flow diagram of an embodiment of a method of roaming within a communication network. A mobile user is using their smart phone to make a call over WIFI; for example, they are using an app installed on their smart phone to make a video call. The mobile device of the mobile user is communicatively coupled to a first access point. As they move further from the first access point, signals from the first access point begin to appear weaker. When the signals are weaker, below a first threshold, but not sufficiently weak to result in unreliable communication, the smartphone inquires of a data store to determine other available WIFI access points. The smartphone selects another WIFI access point as a second other access point, disconnects from its current connection and connects to the second other access point. For example, the user trajectory or direction of movement is used to estimate a direction of travel to determine which of the available networks is most suitable. Alternatively, overall signal strength at a point of network access point switching is used. Further alternatively other predictive, historical, or artificial intelligence models are used to select from available networks. Further alternatively, once the mobile user is determined to be outside the optimal range of the first access point but not out of the actual range of the first access point, the wireless communication signals have an amplitude or signal to noise ratio below a threshold, then the smart phone retrieves from a datastore based on the smart phone's location information about a second other access point for directing communications therethrough.

In some embodiments, information about the second other access point is retrieved as a list of second other access points in ranked order based on suitability i.e., the returned list is sorted based on predicted key performance indicators. Examples of key performance indicators include estimated signal strength, proximity, cost, current load, or some combination of weighted factors. Retrieving a weighted list reduces processing and also allows for network scheduling, performance, and predictions to be implemented centrally. Further, in some embodiments only one single second other access point is retrieved, said single second other access point being a second other access point having a best ranking for the mobile user and the location. Alternatively, each wireless communication device is able to retrieve selectively either a ranked list or a single second other access point allowing a communication device to retrieve a backup second access point at intervals and to retrieve a ranked list of potential second other access points when necessary.

The smart phone connects to the second other access point and disconnects from the first access point allowing for a handoff to be effected rapidly and with little additional power demand on the smart phone. Instead of scanning for new access points as a signal degrades and nears failure, a simple lookup table provides an indication of a suitable access point. Optionally, the lookup table provides credentials for access to the suitable access point. Further optionally, only access points for which the smart phone already has credentials are returned thereto.

When for a location a suitable second access point is not retrieved, the system reverts to blind scanning for suitable access points. In an embodiment, the retrieved access points are then uploaded to a server to be added to the database of second access points. When new access points are added to the database, in some embodiments the system requests of mobile communication devices to scan for access points at different locations in order to fill in the list of access points for each location. In some embodiments a list of second access points is maintained through crowdsourcing.

Referring to FIG. 4, shown is a simplified flow diagram of a smart phone having encountered a failed handoff between access points. Here, the access point is unavailable, for example due to changed authorisation credentials, and therefore, connection to the second other access point fails. The smart phone reports the failure to a process for updating the lookup table and requests a new access point be returned based on a current location of the smart phone. Thus, even when access points fail or smart phones fail to connect, the lookup table can be maintained on a single failure instead of encountering a same failure repeatedly. Optionally, the smart phone and the process for updating the lookup table exchange sufficient information to support a robust and distributable lookup table.

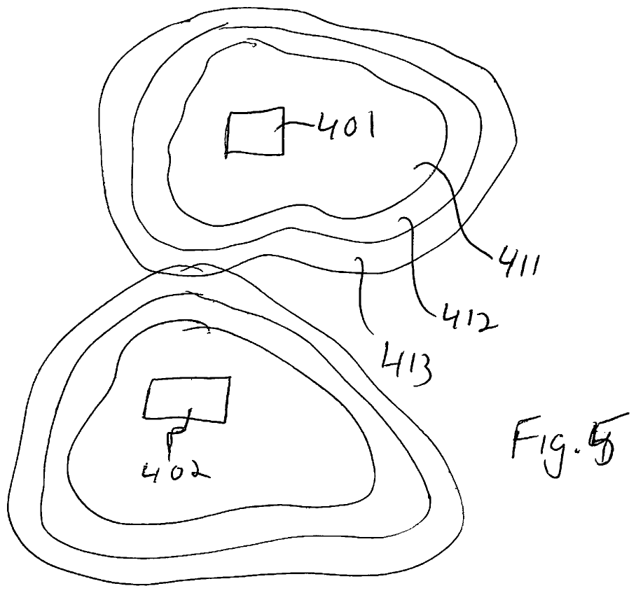

Referring to FIG. 5, shown is a simplified diagram for addressing the handover times for WIFI networks. A mobile communication device in the form of a smartphone is communicatively connected to a WIFI network via access point 401. Another access point 402 is shown. A mobile user is using the smartphone to make a call over the WIFI network 401; for example, they are using an app installed on the smart phone to make a video call. The mobile communication device of the mobile user is communicatively coupled to the WIFI network 401 via a first access point. At 402 as the user moves further from the first access point, from 411 to 412 signals from the first access point appear weaker at the smartphone. The smartphone determines a signal quality of a received signal. If the signal quality is adequate, then the smartphone maintains communication. If the signal quality is below a first threshold above an acceptable quality level for example in area 413, the smartphone determines its geolocation and looks up other available access points for its geolocation. This is done by referencing a lookup table of access points indexed by geolocation. Within at least a returned second access point, one of the at least a second access point is selected; for example the one with the highest priority that is accessible to the smartphone is selected. Once selected, the smartphone switches from communicating via the first access point to communicating via the one of the at least a second access point, resulting in a far shorter period during which communication is interrupted. In fact, when a device supports transmission via two access points simultaneously, a connection to the second access point occurs before the connection to the first access point is dropped. Even when this is not the case, by ensuring that communication with the first access point is acceptable when the transfer is made, the period during which communication is compromised is reduced. When the at least a second access point comprises only the first access point, then communication is maintained via the first access point until another access point is returned or until communication is lost. In another embodiment, a second access point is determined for each location during movement in order to have a backup access point for switching when necessary. Such a process is often implemented with little to no effect on data communication, providing a known and updated alternative access point for a roaming system as it moves. When some available access points have an additional cost, then the cost is evaluated as part of selecting one of the at least an access point. For example, the first access point is selected until its signal quality is below a second lower threshold.

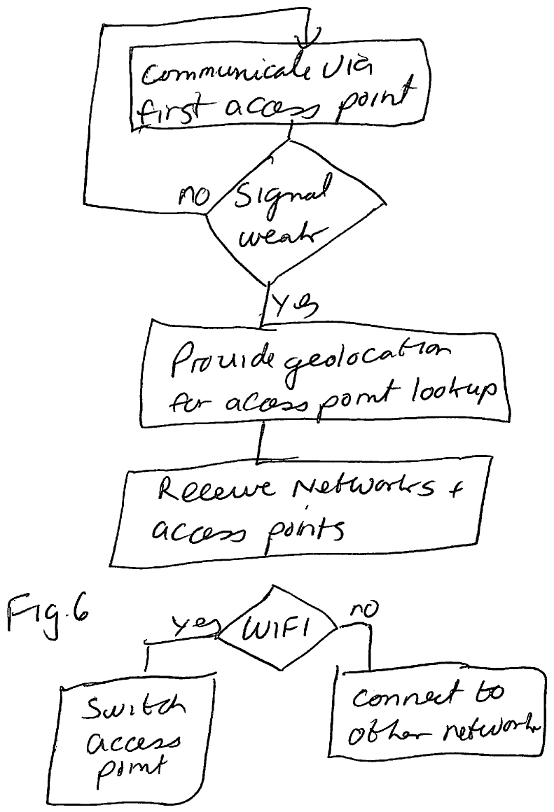

Referring to FIG. 6, shown is a simplified flow diagram for addressing the handover times from WIFI to cellular networks. A Smartphone is connected to a WIFI network. The smartphone determines a signal quality. If the signal quality is adequate, then it maintains communication. If the signal quality is below an acceptable quality level, the smartphone determines its geolocation and looks up available access points and other available networks. This is done by referencing a lookup table of available networks indexed by geolocation. Within the determined available networks, no WIFI access point is found so an available cellular network and tower/access point with the highest priority that is accessible to the smartphone is selected. Once selected, the smartphone ensures proper connection to cellular data network and switches from the first access point to the cellular data network, resulting in virtually no noticeable period during which communication is interrupted. In fact, because the smartphone supports connection via WIFI and cellular simultaneously, a connection to the cellular network occurs before the connection to the first access point is dropped. Even when simultaneous connection is not supported, since the WIFI network communications remain adequate when switching is initiated, any interruption is typically very short.

By relying on a lookup table, the system and method support verifiable a priori data that enhances decision making. For example, a geolocation server maintains a list of geolocations and access points for multiple networks. Each time a smartphone transitions between, for example, WIFI networks, the transition physical networking information is provided to allow the database to be updated. For example, the database may include times when WIFI networks are accessible, bandwidth projections for WIFI networks, actual bandwidth availability for WIFI networks, WIFI network passwords, WIFI network routing information, etc. When updated regularly, such a database would provide an adequate indication of available network communication options for a particular user in terms of their knowledge of the network, their knowledge of authentication information of the network, how many networking options exist for a specific location, which options appear most desirable, etc. Instead of a process of failure—discover—selection—authentication, the process is shortened to authentication. When an authentication fails, the system can lookup a secondary networking option Alternatively, several networking options are provided when available for a geolocation allowing the smartphone to switch to a secondary option if authentication to the primary option fails.

When a device fails to authenticate to the primary network option, optionally a user of the device is notified and can enter authentication information later or manually switch back to the primary network. In either case, the user's communication session need not be interrupted due to loss of signal. In an embodiment, a user is informed of a change in network access. In another embodiment, the user is informed of a change in network protocol such as a change from WIFI to cellular.

The lookup table-based access point selection also supports access points that do not broadcast their information. Further, it allows for more complex lookup decisions such as evaluating current processes in execution on the smart phone to determine if and when a change is required. For example, a user in a video-conference call needs high quality continuous communication whereas a user reading long text-based articles often requires little bandwidth that need not be uninterrupted. Analysis of processes and location leads to a different access point selection in some instances.

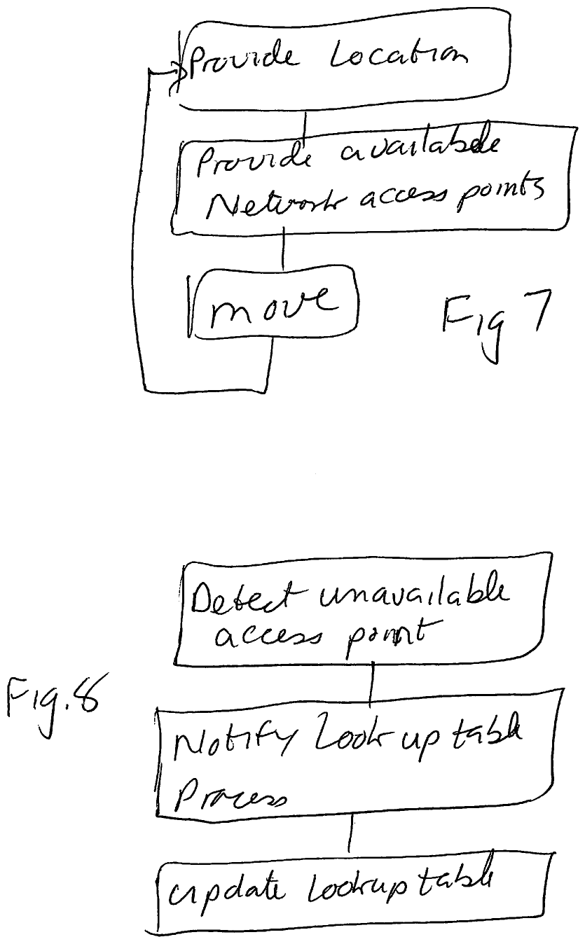

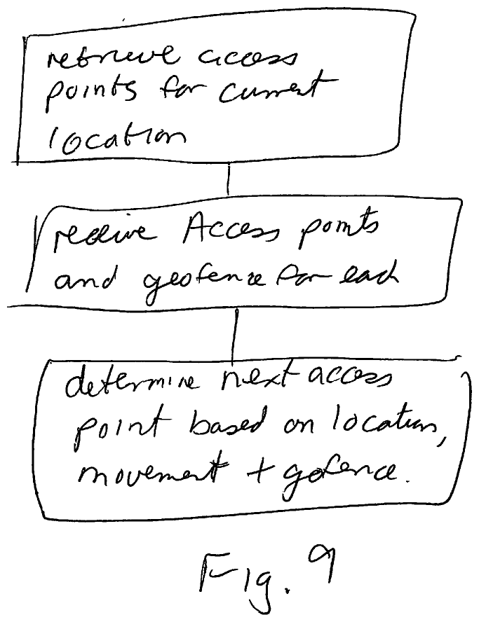

Referring to FIG. 7, shown is a simplified flow diagram for forming a lookup table. Here, each time a mobile device moves, a lookup table formation process is notified and captures data on access points and geolocations of the mobile device. After a reasonable length of time, most locations have associated access point information and the lookup table is put to use. When the user enters areas that are not covered by the lookup table, the user is provided the option to fill in the lookup table in order to improve networking.

Alternatively, for each location data is captured from multiple devices to form a shared lookup table, the data relating to access points and geolocations and device types. Thus, the lookup table that results accommodates many devices. Such a lookup table is stored accessible to the devices it relates to. Alternatively, it is uploaded to each device and used locally.

Referring to FIG. 8, shown is a simplified diagram of a lookup table being maintained. Here, a mobile device uploads its geolocation to the lookup table and is provided a list of access points. Some of the access points are inaccessible and the lookup table is provided feedback data that is then used to temporarily affect the lookup table or its results. Thus, failure of an access point might be tested daily for 3 or four days. Maintaining a lookup table in this way allows for the lookup table to remain useful and effective even as changes in the network, such as power outages, etc., occur. In the extreme case where an access point is not reachable for a length of time, for example a week, then the access point is removed from the lookup table and the table itself is permanently modified.

In an embodiment, the lookup table includes multidimensional data indexed on multiple fields such as geolocation, time, and bandwidth requirements. This allows a smart phone to request access points based on time of day, bandwidth needs/application requirements, and location. In another embodiment, the lookup table includes vector information for predicting a best access point for a mobile device in motion based on its location and direction of travel. In yet another embodiment, the lookup table contains data that is used by a lookup process that computes direction of travel.

In some embodiments, access points are stored in a lookup table on a mobile device to allow for local access. In other embodiments, the lookup table data is stored in the cloud and a portion of the lookup table is uploaded to each mobile device. In yet another embodiment, the lookup table is only stored within the cloud. In some embodiments a lookup table includes access points that are other than WIFI access points.

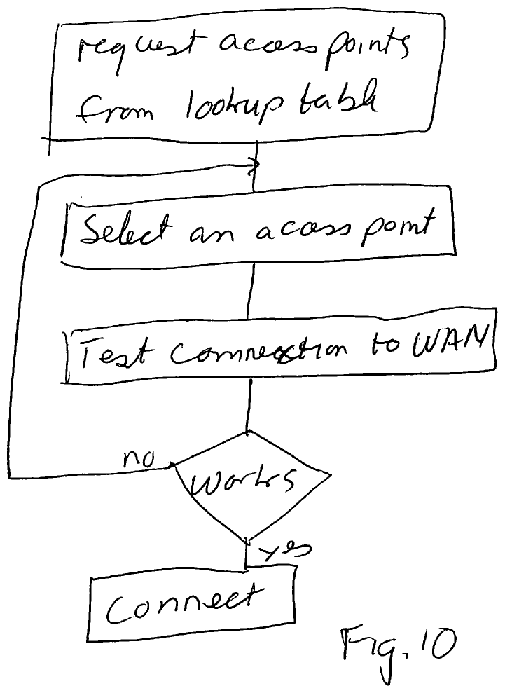

Referring to FIG. 9, shown is a simplified flow diagram of a method of relying on a lookup table for transitioning between access points wherein the lookup table includes geofences for each access point. Here, each access point includes two geofences, a first geofence where signal degrades and a second other geofence proximate a boundary of signal failure. Thus, within the first geofence, communication occurs normally. Once a mobile device is between the first geofence and the second other geofence, the mobile device queries the lookup table for a second other access point. The selection of access points to return is optionally affected by their geofences. For example, a second access point with nearly an identical geofence might be less desirable than a second access point with considerable overlap in its geofenced area and considerable non-overlapping geofenced area. In some embodiments, the geofence data indicates where a mobile device should ideally transfer to another access point given that it has access to the current access point and the one to which it should transfer. By knowing which access points are accessible and a geofence for each, locations and access points are determinable using predictive algorithms.

In an embodiment, a process for maintaining the lookup table pings each access point via the Wide Area Network to determine a load and availability of each access point. The lookup table is then maintained to provide up to date suitable options for next access point(s). Optionally, the additional data relating to availability and load is uploaded to the mobile device at intervals to support a local lookup table that is maintained and current.

In some embodiments, information about the second other access point is retrieved as a list of second other access points in ranked order based on suitability i.e., the returned list is sorted based on predicted key performance indicators. Examples of key performance indicators include estimated signal strength, proximity, cost, current load, or some combination of weighted factors. Retrieving a weighted list reduces processing and also allows for network scheduling, performance, and predictions to be implemented centrally. Further, in some embodiments only one single second other access point is retrieved, said single second other access point being a second other access point having a best ranking for the mobile user and the location. Alternatively, each wireless communication device is able to retrieve selectively either a ranked list or a single second other access point allowing a communication device to retrieve a backup second access point at intervals and to retrieve a ranked list of potential second other access points when necessary.

In an embodiment, the lookup table relies on location and direction data. In another embodiment the lookup table relies on location and previous location data. In yet another embodiment, each lookup table is unique to a user such that the lookup table accommodates some common movements of the user. In yet another embodiment, the lookup table is tiled to support a geographic region and new tiles are uploaded as a mobile device moves between regions or within proximity of another region. In an embodiment, access points are reviewed in a cloud-based process for load and other parameters for each access point in order to enhance ranking evaluation for access points.

When for a location a suitable second access point is not retrieved, the system reverts to blind scanning for suitable access points. In an embodiment, the retrieved access points are then uploaded to a server to be added to the database of second access points. When new access points are added to the database, in some embodiments the system requests of mobile communication devices to scan for access points at different locations in order to fill in the list of access points for each location. Thus, in some embodiments a list of second access points is maintained through crowdsourcing.

In another embodiment, shown in FIG. 10, a request is made of the lookup table for an access point. The lookup table provides suitable access points and the mobile device pings a selected access point, selected from the provided access points, to determine if it is accessible via the Internet. When it is available, it is selected. When it is unavailable, another access point from the provided access points is selected.

Numerous other embodiments may be envisaged without departing from the scope of the invention.

What is claimed is:

1. A method comprising:
providing a mobile communication device in communication with a first access point via a first protocol;
providing a lookup table comprising data relating to access points and geographical location data;
determining a location of a mobile communication device in relation to the geographical location data;
retrieving from the lookup table a second other access point accessible based on the location of the mobile communication device; and
wirelessly connecting the mobile communication device to the second other access point; and
disconnecting the mobile communication device from the first access point.

2. A method according to claim 1 wherein wirelessly connecting is performed via the first protocol.

3. A method according to claim 2 wherein the first protocol is a WIFI protocol.

4. A method according to claim 3 wherein wirelessly connecting is performed via a second other protocol.

5. A method according to claim 1 wherein the first protocol is a WIFI protocol.

6. A method according to claim 1 wherein
determining a location of a mobile communication device in relation to the geographical location data; and
retrieving from the lookup table a second other access point accessible based on the location of the mobile communication device;
are performed when a signal quality of mobile communication via the first protocol is below a first threshold.

7. A method according to claim 6 wherein the first threshold is sufficient for continued high quality communication.

8. A method according to claim 6 wherein the first threshold is selected to allow continued high-quality communication until a process for wirelessly connecting the mobile communications device to the second other access point is initiated.

9. A method according to claim 6 wherein the first threshold is selected to allow continued high-quality communication until wirelessly connecting the mobile communications device to the second other access point is completed.

10. A method according to claim 1 wherein retrieving is performed in dependence upon an identifier from the mobile communication device and wherein the second other access point is selected from access points accessible to the mobile communication device.

11. A method according to claim 1 wherein the first protocol is a wireless protocol for stationary device communication.

12. A method according to claim 11 wherein the second other access point is accessed via the first protocol.

13. A method according to claim 1 wherein first data relating to the second other access point is stored within the mobile communication device and wherein wirelessly connecting the mobile communication device to the second other access point is performed for fewer than all second other access points for which first data is stored.

14. A method according to claim 13 wherein wirelessly connecting the mobile communication device to the second other access point is performed when the communication with the first access point has a signal quality below a first known threshold.

15. A method according to claim 13 wherein wirelessly connecting the mobile communication device to the second other access point is performed when the communication with the first access point has a signal quality having a ratio with the expected signal quality of the second other access point below a first known threshold ratio.

16. A method according to claim 13 wherein wirelessly connecting the mobile communication device is performed via a WIFI standard.

17. A method according to claim 16 wherein the first threshold represents a quality of communication that is below a highest quality but above a quality level that substantially impedes communication quality.

18. A method according to claim 16 wherein the first threshold represents a quality of communication that is statistically likely to be below other available access points for any given geographic location.

19. A method comprising:
providing a lookup table comprising data relating to access points and geographical location data;
providing a first access point; and
providing a first mobile communication device in communication with the first access point;
when a signal quality received at the first mobile device is below a first threshold,
a) determining a location of the first mobile communication device
b) retrieving from the lookup table access points other than the first access point accessible from the location of the first mobile communication device;
c) disconnecting from the first access point; and
d) connecting to a one of the retrieved access points.

20. A method comprising:
providing a lookup table comprising data relating to a plurality of geographical locations and for each location an associated access point and quality level for said associated access point;
providing a mobile communication device in communication with a network via a first access point of the plurality of access points;
determining a location of the mobile communication device;
retrieving from the lookup table at least a second access point accessible from the location of the mobile communication device and having a higher quality level associated therewith;
when the first access point has a quality level above a predetermined threshold and is one of the at least a second access point, maintaining wireless communication via the first access point; and
when the current access point is at least one of below the predetermined threshold and other than one of the at least a second access point, wirelessly communicating with the network via an access point of the at least a second access point.
